(19) United States
(12) Patent Application Publication
(10) Pub. No.: US 2017/0149893 A1
(43) Pub. Date: May 25, 2017

(54) METADATA SERVER, NETWORK DEVICE AND AUTOMATIC RESOURCE MANAGEMENT METHOD

(71) Applicant: Institute For Information Industry, Taipei (TW)

(72) Inventors: Po Hsuan WU, Taipei City (TW); Shang Hao CHUANG, Taipei City (TW); Yi Chen SHIH, Nantou City (TW); Hsin Tse LU, Taipei City (TW)

(21) Appl. No.: 14/965,729

(22) Filed: Dec. 10, 2015

(30) Foreign Application Priority Data
Nov. 19, 2015 (TW) 104138255

(51) Int. Cl. H04L 29/08; H04L 12/24

(52) U.S. Cl. CPC H04L 67/1097; H04L 41/12; H04L 41/0816

(57) ABSTRACT

A metadata server, a network device and an automatic resource management method for the metadata server are provided. The metadata server connects to a plurality of storage servers and a plurality of user devices, and stores system topology information which records connection relationships between the storage servers and the user devices. The metadata server detects whether a system change event occurs between the metadata server and a target storage server. When the system change event occurs, the metadata server updates the system topology information, generates a notification message in response to the update on the system topology information, and transmits the notification message to at least one relevant user device of the user devices. The at least one relevant user device may include the network device.

### PRIORITY

This application claims the benefit of priority based on Taiwan Patent Application No. 104138255 filed on Nov. 19, 2015, which is hereby incorporated by reference in its entirety.

### FIELD

The present invention relates to a metadata server, a network device and an automatic resource management method for use in a metadata server. More particularly, the metadata server, the network device and the automatic resource management method of the present invention are used to implement an automatic resource management mechanism of a distributed file system (DFS).

### BACKGROUND

With the vigorous development of the computer network technologies in recent years, various types of network services (e.g., social networking, cloud storage, etc.) become ubiquitous in people's life. In order to manage data rapidly accumulated by numerous users and provide sufficient storage spaces, the architecture of a distributed file system (DFS) has been proposed.

A conventional DFS uses a metadata server to manage, in a centralized way, storage servers and user devices distributed over a network. A user may operate his or her user device to connect the user device to the metadata server via the network so that resource allocation information can be acquired from the metadata server and to connect the user device to a particular storage server via a particular transmission protocol (e.g., a block transmission protocol) based on the resource allocation information. When the user device wants to access particular data from the storage server, the user device needs to access the metadata server to obtain metadata information related to the particular data before accessing a data storage block storing resources in the storage server.

However, every time a storage server is added into the DFS under the architecture of the conventional DFS, the manager of the metadata server needs to manually allocate a storage resource of the added storage server according to the status of the overall storage server at that time, e.g., allocate the storage resource of the added storage server to an existing shared folder to increase the storage resource of the shared folder. In response to the update on the shared folder, the manager needs to instruct the users of relevant user devices one by one so that the users further operate the user devices to set respective connection configurations for connection to the added storage server, thereby achieving synchronization of the system resource allocation. As can be known from this, in the management mechanism of the conventional DFS, the manager of the metadata server needs to manually allocate the storage resources and instruct the users of the user devices to set the connection configuration, and this not only represents complicated and labor-consuming operations but also makes it impossible to allow the user devices to change their connection configuration settings in real time in response to the update on the shared folder.

Accordingly, an urgent need exists in the art to provide a management mechanism for the DFS which can effectively reduce the complicated manual operations and allow the user devices to change their connection configuration settings in real time in response to the update on the shared folder.

### SUMMARY

The disclosure includes an automatic management mechanism for a distributed file system (DFS). The present invention records connection relationships between a plurality of storage servers and a plurality of user devices via a metadata server, and automatically detects system change events of the storage servers to update system topology information. Meanwhile, in response to the system change events, the metadata server automatically transmits a notification message to the user device, which needs to reset the connection configuration, in real time according to the recorded connection relationships. Accordingly, the automatic management mechanism of the present invention can effectively reduce the complicated manual operations in the DFS and allow the user devices to change their connection configuration settings in real time in response to the update on a shared folder.

The disclosure includes a metadata server for a distributed file system (DFS), and the metadata server comprises a network interface, a storage and a processor. The DFS comprises the metadata server, a plurality of storage servers and a plurality of user devices. The processor is electrically connected to the network interface and the storage. The metadata server is connected to a network via the network interface and is connected to the storage servers and the user devices via the network. The storage is configured to store system topology information. The system topology information records connection relationships between the storage servers and the user devices. The processor is configured to execute the following operations: detecting whether a first system change event occurs between the metadata server and a target storage server; and if the first system change event occurs, then updating the system topology information according to the first system change event, generating a notification message in response to the update on the system topology information; and transmitting the notification message to at least one relevant user device among the user devices via the network interface according to the connection relationships recorded in the system topology information.

The disclosure further includes an automatic resource management method for a metadata server. The metadata server is used in a distributed file system (DFS). The DFS comprises the metadata server, a plurality of storage servers and a plurality of user devices. The metadata server comprises a network interface, a storage and a processor. The network interface is connected to the storage servers and the user devices via a network. The storage stores system topology information. The system topology information records connection relationships between the storage servers and the user devices. The automatic resource management method is executed by the processor and comprises the following steps of: (a) detecting whether a first system change event occurs between the metadata server and a target storage server; and (b) if the first system change event occurs, then updating the system topology information according to the first system change event, generating a notification message in response to the update on the system topology information, and transmitting the notification message to at least one relevant user device among the user devices via the network interface according to the connection relationships recorded in the system topology information.

The disclosure also includes a network device, and the network device comprises a storage, a network interface and a processor. The processor is electrically connected to the network interface and the storage. The storage stores a connection configuration. The network interface is connected to a network and is connected to a metadata server via the network. The metadata server stores system topology information. The system topology information records connection relationships between the storage servers and the user devices. The metadata server detects whether a system change event occurs between the metadata server and a target storage server. If the first system change event occurs, the metadata server updates the system topology information according to the system change event, generates a notification message in response to the update on the system topology information, and transmits the notification message to at least one relevant user device among the user devices according to the connection relationships recorded in the system topology information. If the network device is one of the at least one relevant user device, the network interface receives the notification message from the metadata server.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a metadata server 11 according to a first embodiment of the present invention;

FIG. 2 is a schematic view of a network device 13 according to the first embodiment of the present invention;

FIG. 3 is a schematic view of a distributed file system (DFS) 3 according to the first embodiment of the present invention;

FIG. 4 depicts adding a target storage server (i.e., a storage server S4) into the DFS 3;

FIG. 5 depicts removing a target storage server (i.e., a storage server S3) from the DFS 3;

FIG. 6 depicts relationships between the shared folders D1, D2 and D3 in a storage 113 of the metadata server 11 and the storage servers S1, S2 and S3 and the user devices UE1, UE2 and UE3;

FIG. 7 depicts adding a shared folder D4 and allocating a storage resource of a target storage server to the shared folder in response to that the target storage server (i.e., the storage server S4) is added into the DFS 3, according to the second embodiment of the present invention;

FIG. 8 depicts allocating a storage resource of a target storage server to the shared folder D1 in response to that the target storage server (i.e., the storage server S4) is added into the DFS 3, according to the second embodiment of the present invention;

FIG. 9 depicts removing a target storage server (i.e., the storage server S3) from the DFS 3 according to an embodiment of the present invention;

FIG. 10 depicts adding a target user device (i.e., a user device UE4) into the DFS 3 according to a third embodiment of the present invention;

FIG. 11 depicts removing a target user device from the DFS 3 according to the third embodiment of the present invention;

FIG. 12 illustrates a flowchart of an automatic resource management method according to a fourth embodiment of the present invention; and

FIG. 13 illustrates a flowchart of an automatic resource management method according to a fifth embodiment of the present invention.

### DETAILED DESCRIPTION

In the following description, the present invention will be explained with reference to certain example embodiments thereof. However, these example embodiments are not intended to limit the present invention to any specific example, embodiment, environment, applications or implementations described in these example embodiments. Therefore, description of these example embodiments is only for purpose of illustration rather than to limit the scope of the present invention. It shall be appreciated that, in the following embodiments and the attached drawings, elements unrelated to the present invention are omitted from depiction.

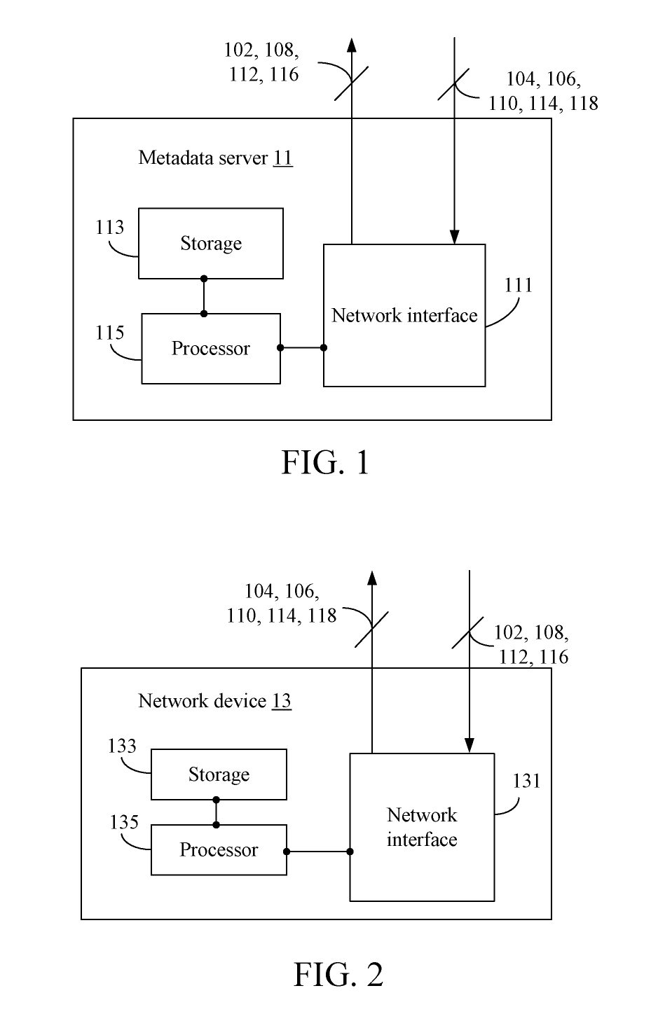

FIG. 1 is a schematic view of a metadata server 11 according to a first embodiment of the present invention. The metadata server 11 comprises a network interface 111, a storage 113 and a processor 115. The processor 115 is electrically connected to the network interface 111 and the storage 113. The network interface 111 is connected to a network (not shown), and the network may be a local network, the Internet, a telecommunication network or any combination thereof, but it is not limited thereto. The storage 113 may be a flash memory, a hard disk or any storage medium having the same function.

FIG. 2 is a schematic view of a network device 13 according to the first embodiment of the present invention. The network device 13 is a user device and comprises a network interface 131, a storage 133 and a processor 135. The processor 135 is electrically connected to the network interface 131 and the storage 133. The network interface 131 is also connected to the aforesaid network, and the storage 133 may also be a flash memory, a hard disk or any storage medium having the same function.

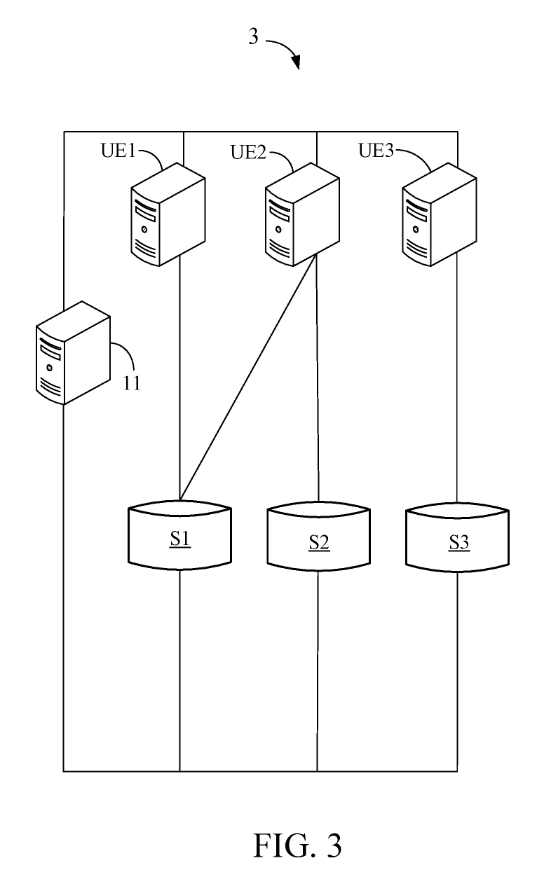

Please refer to FIG. 3, which depicts a distributed file system (DFS) 3, for the first embodiment of the present invention. The DFS 3 comprises a metadata server 11, a plurality of storage servers S1, S2 and S3 and a plurality of user devices UE1, UE2 and UE3. A user device 2 may be any of the user devices UE1, UE2 and UE3. It shall be appreciated that, the DFS 3 comprising three user devices UE1, UE2 and UE3 and three storage servers S1, S2 and S3 is only taken as an exemplary example in this embodiment for simplification of description. However, it shall be appreciated by those of ordinary skill in the art that, the number of the storage servers and the number of the user devices are not intended to limit the claimed scope of the present invention, and the maximum number of the storage servers and the user devices depends on the processing capacity of the metadata server 11. Moreover, it shall also be appreciated by those of ordinary skill in the art that, each of the user devices UE1, UE2 and UE3 is any device that may be connected to the metadata server 11 and any of the storage servers S1, S2 and S3 respectively based on particular transmission protocols (e.g., each of the user devices may be connected to the storage server based on the block transmission protocol). Moreover, in this embodiment, the block transmission protocol may be an Internet small computer system interface (iSCSI) storage protocol, but it is not limited thereto.

In this embodiment, the storage 133 of the metadata server 11 stores system topology information which records connection relationships between the storage servers S1, S2 and S3 and the user devices UE1, UE2 and UE3. The processor 115 of the metadata server 11 detects whether a first system change event occurs between the metadata server 11 and a target storage server. If the first system change event occurs, then the processor 115 updates the system topology information stored in the storage 13 according to the first system change event, and generates a notification message 102 in response to the update on the system topology information. Thereafter, the processor 115 transmits the notification message 102 to at least one relevant user device among the user devices UE1, UE2 and UE3 via the network interface 111 according to the connection relationships recorded in the system topology information. Therefore, when the network device 13 belongs to one of the at least one relevant user device, the network interface 131 of the network device 13 receives the notification message 102 from the metadata server 11.

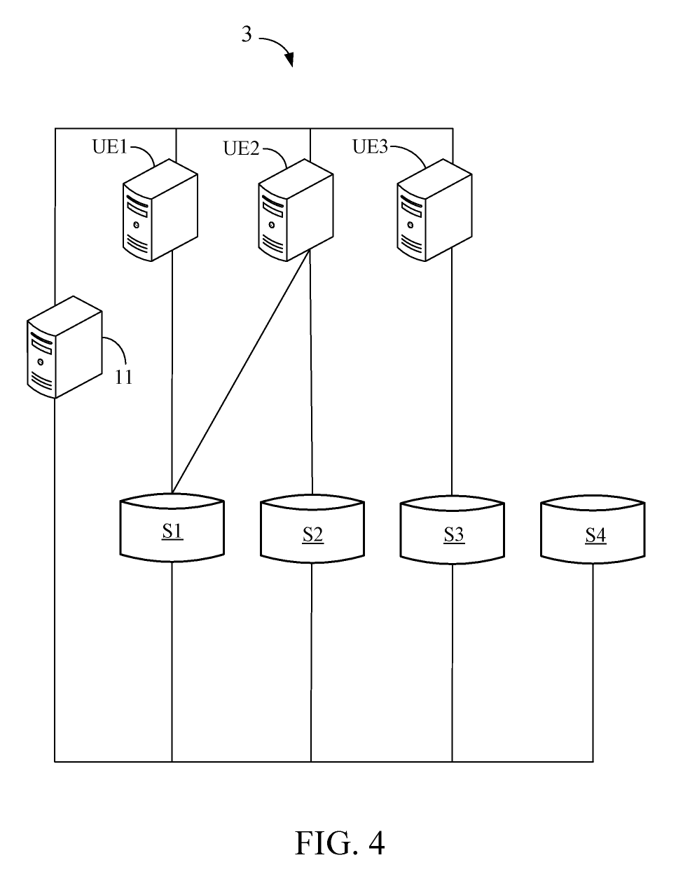

For example, as shown in FIG. 4, when a target storage server (i.e., a storage server S4) is added into the DFS 3, the first system change event is to add the target storage server into the DFS 3. In this case, the processor 115 may transmit the notification message 102 to the at least one relevant user device via the network interface 111 so that each of the at least one relevant user device adds connection information of the target storage server into a connection configuration stored in the relevant user device according to the notification message 102. Accordingly, when the network device 13 belongs to one of at least one relevant user device, the processor 135 of the network device 13 adds the connection information of the target storage server into the connection configuration stored in the storage 133 according to the notification message 102 so as to try to connect to the target storage sever via the network interface 131 according to the connection configuration.

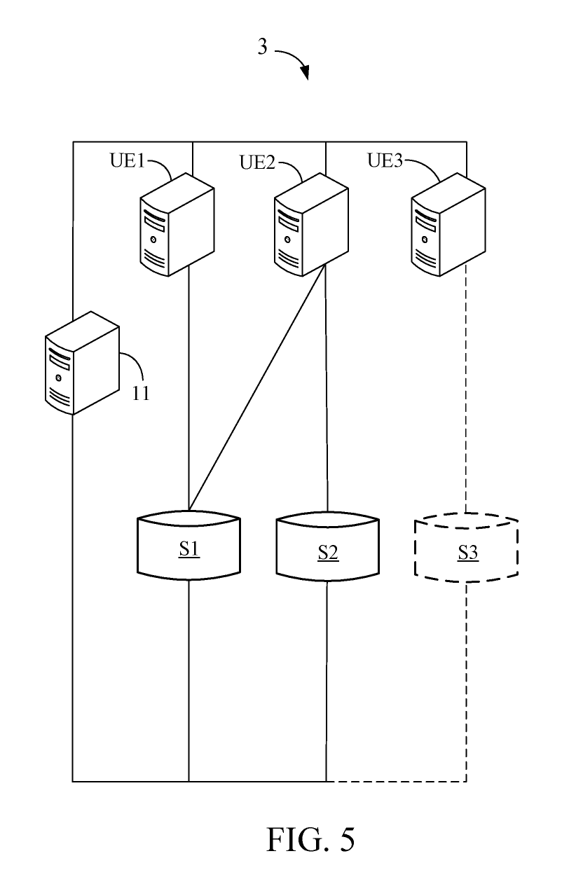

As another example, as shown in FIG. 5, when a target storage server (i.e., a storage server S3) is removed from the DFS 3, the first system change event is to remove the target storage server from the DFS 3. In this case, the processor 115 may transmit the notification message 102 to the at least one relevant user device via the network interface 111 so that each of the at least one relevant user device removes the connection information of the target storage server from the connection configuration stored in the relevant user device according to the notification message 102. Accordingly, when the network device 13 belongs to one of at least one relevant user device, the processor 135 of the network device 13 removes the connection information of the target storage server from the connection configuration stored in the storage 133 according to the notification message 102. In other words, the processor 135 of the network device 13 interrupts a connection with the target storage server via the network interface 131 and removes the connection information from the connection configuration stored in the storage 133.

As described above, in response to that the first system change event is detected, the metadata server 11 of the present invention may automatically update the stored system topology information and transmit the notification message 102 to the user device related to the first system change event based on the connection relationships recorded in the system topology information so that the user device can update the connection configuration thereof in response to the notification message 102.

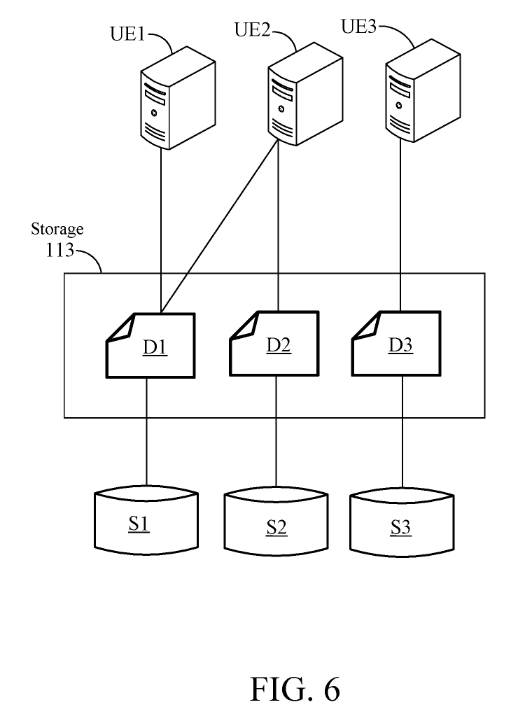

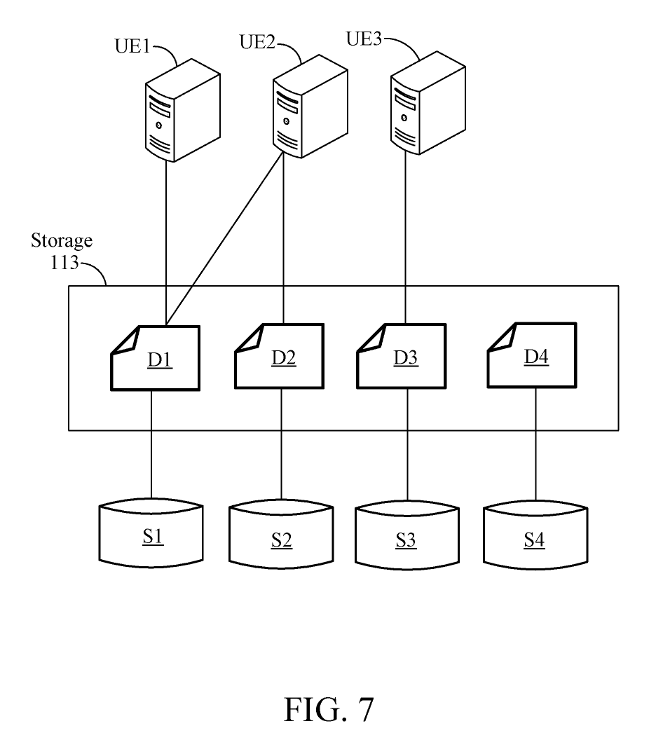

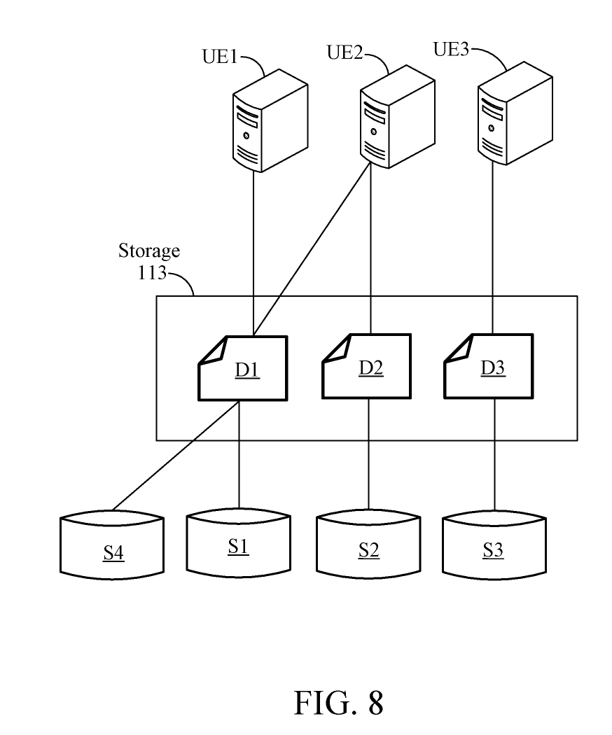

Please further refer to FIG. 6, FIG. 7 and FIG. 8 for a second embodiment of the present invention. The second embodiment is an extension of the first embodiment and further describes how the metadata server 11 processes the first system change event. FIG. 6 depicts relationships between the shared folders D1, D2 and D3 in the storage 113 of the metadata server 11 and the storage servers S1, S2 and S3 and the user devices UE1, UE2 and UE3, and these relationships are recorded in the system topology information. In detail, the system topology information records that the metadata server 11 allocates the storage source of the storage server S1 to the shared folder D1, allocates the storage source of the storage server S2 to the shared folder D2, and allocates the storage source of the storage server S3 to the shared folder D3.

For the first system change event, the metadata server 11 may be set to perform operations in response according to an allocation policy. For example, as shown in FIG. 7, when the target storage server (i.e., the storage server S4) is added into the DFS 3, the processor 115 may add a shared folder D4 in the storage 113 so as to allocate a storage resource of the target storage server into the shared folder D4 and update the system topology information in the storage 113.

As another example, as shown in FIG. 8, when the target storage server (i.e., the storage server S4) is added into the DFS 3, the processor 115 may further determine that the number of shared folders has reached a threshold (in this example, it is assumed that the threshold is 3) so as to allocate a storage resource of the target storage server to an existing shared folder (the shared folder D1) in the storage 113 and update the system topology information. In this case, the processor 115 generates the notification message 102 and transmits the notification message 102 to the user devices UE1 and UE2 via the network interface 111 so that each of the user devices UE1 and UE2 adds the connection information of the storage server S4 into the connection configuration thereof. In this way, each of the user devices UE1 and UE2 may try to connect to the storage server S4 according to the connection configuration thereof. However, if the number of shared folders has not reached the threshold, then the processor 115 may add a shared folder in the storage 113 so as to allocate a storage resource of the target storage server into the added shared folder and update the system topology information in the storage 113, i.e., as shown in FIG. 7.

As another example, as also shown in FIG. 8, when the target storage server (i.e., the storage server S4) is added into the DFS 3, the processor 115 may further calculate a storage resource of each of the storage servers S1, S2 and S3 so as to allocate a storage resource of the target storage server to a shared folder of one of the storage servers which has the minimum storage resource (in this example, it is assumed that the storage resource of the storage server 1 is the minimum, so the storage resource of the storage server S4 is allocated to the shared folder D1) and update the system topology information. In other words, the processor 115 determines of which shared folder the storage resource needs to be expanded to a greater extent, and then allocates the storage resource of the added storage server to this shared folder. Similarly, in this case, the processor 115 generates the notification message 102 and transmits the notification message 102 to the user devices UE1 and UE2 via the network interface 111 so that each of the user devices UE1 and UE2 adds connection information of the target storage server S4 into the connection configuration thereof.

In another embodiment, after the metadata server 11 transmits the notification message 102 to the at least one relevant user device, the processor 115 further receives an execution code 104 from each of the at least one relevant user device respectively and, for each of the execution codes 104, the processor 115 further determines whether the execution code 104 is in a successful status, and if the execution code 104 is in the successful status, then the processor 115 updates the system topology information. On the contrary, if the execution code 104 is in a failed status, then the system topology information will not be updated. For example, when the network device 13 belongs to one of the at least one relevant user device (e.g., one of the user devices UE1 and UE2 of FIG. 8), the processor 135 of the network device 13 adds the connection information of the target storage server into the connection configuration stored in the network device 13 according to the notification message 102, then further tries to connect to the target storage server (i.e., the storage server S4) via the network interface 131 according to the connection configuration, generates the execution code 104 based on the connection result and transmits the execution code 104 to the metadata server 11 via the network interface 131.

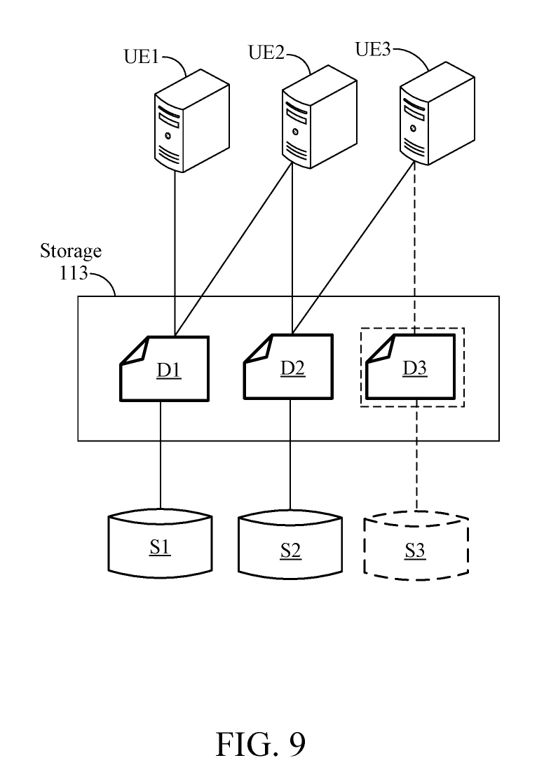

Moreover, in other embodiments, as shown in FIG. 9, when the first system change event is to remove the target storage server (e.g., the storage server S3) from the DFS 3, the processor 115 may delete the shared folder D3 in the storage 113. In response to the aforesaid allocation, the processor 115 generates the notification message 102, transmits the notification message 102 to the user device UE3 via the network interface 111 so that the user device UE3 removes the connection information of the storage server S3 from the connection configuration of the user device UE3.

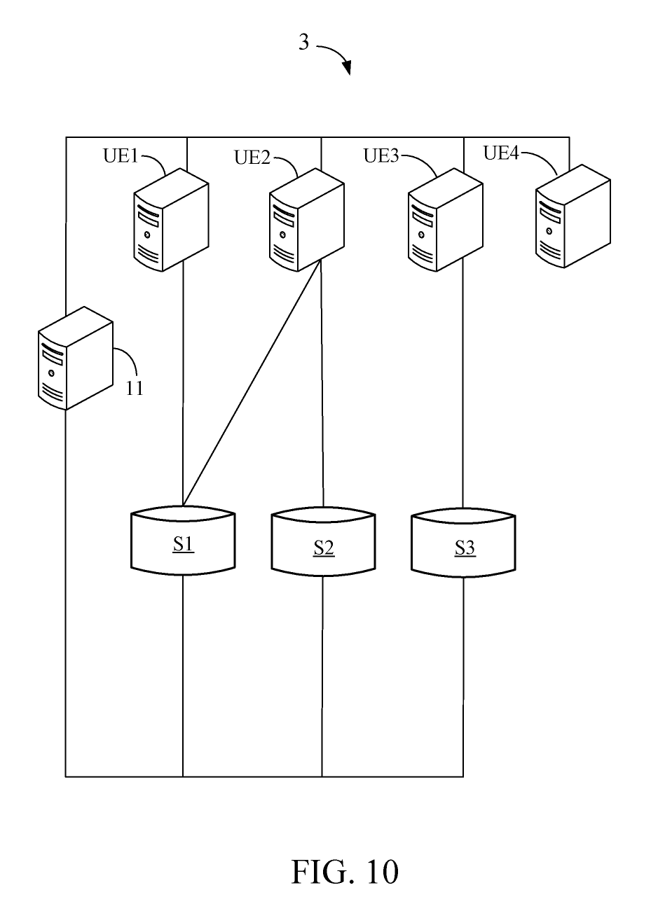

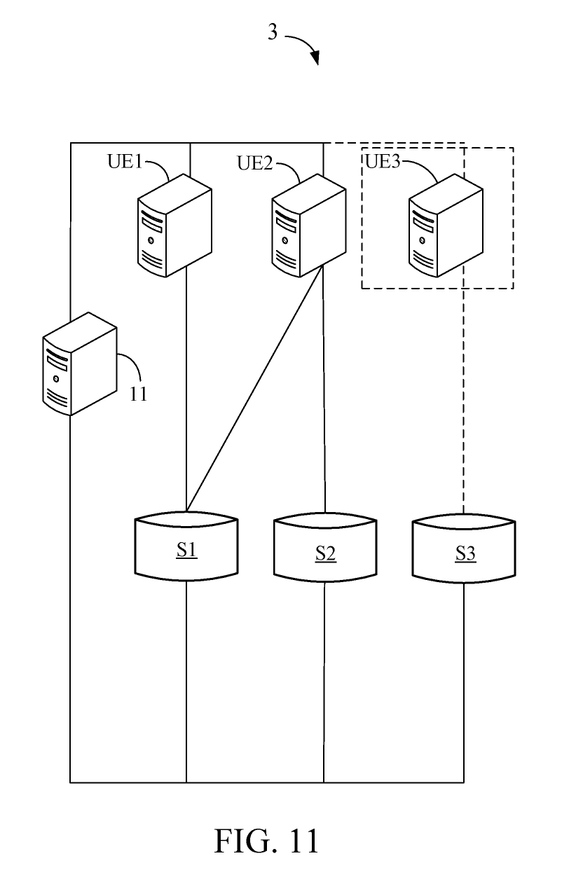

A third embodiment of the present invention is as shown in FIG. 1, FIG. 10 and FIG. 11. The third embodiment is an extension of the first embodiment. In this embodiment, in addition to detecting whether a first system change event occurs between the metadata server 11 and a target storage server, the processor 115 of the metadata server 11 further detects whether a second system change event occurs between the metadata server 11 and a target user device.

Specifically, as shown in FIG. 10, when the second system change event is to add the target user device (i.e., the user device UE4) into the DFS 3, the processor 115 receives a topology information request message 106 from the target user device via the network interface 111 so as to generate a topology information report message 108 according to the topology information request message 106 and transmit the topology information report message 108 to the target user device via the network interface 111. In this way, the target user device selects at least one shared folder from the storage 111 according to the topology information report message 108 and transmits a connection information request message 110 to the metadata server 11. Then, after the connection information request message 110 is received via the network interface 111, the processor 115 further transmits a connection information report message 112 to the target user device via the network interface 111 so that the target user device adds connection information of at least one of the storage servers S1, S2 and S3 into a connection configuration stored in the target user device.

For example, when the network device 13 is the target user device (i.e., the user device UE4), the processor 135 of the network device 13 transmits the topology information request message 106 to the metadata server 11 via the network interface 131 and receives the topology information report message 108 from the metadata server 11 via the network interface 131. Thereafter, the processor 135 selects at least one shared folder (at least one of the shared folders D1, D2 and D3) from the metadata server 11 according to the topology information report message 108 to generate a connection information request message 110 and transmits the connection information request message 110 to the metadata server 11 via the network interface 131. Then, the processor 135 receives the connection information report message 112 via the network interface 131 to add connection information of at least one of the storage servers S1, S2 and S3 into the connection configuration.

On the other hand, as shown in FIG. 11, when the second system change event is to remove the target user device (i.e., the user device UE3) from the DFS 3, the processor 115 receives a logout request message 114 from the target user device via the network interface 111 and generates a logout response message 116 in response to the logout request message 114 and transmits the logout response message 116 to the target user device via the network interface 111 so that the target user device removes connection information of at least one of the storage servers S1, S2 and S3 from the connection configuration stored in the target user device in response to the logout response message 116.

For example, when the network device 13 is the target user device (i.e., the user device UE3), the processor 135 of the network device 13 generates the logout request message 114 and transmits the logout request message 114 to the metadata server 11 via the network interface 131. Thereafter, the processor 135 receives the logout response message 116 from the metadata server 11 via the network interface 131 so as to remove connection information of at least one of the storage servers from the connection configuration in response to the logout response message 116 (in this example, the processor 135 removes the connection information of the storage server S3 from the connection configuration).

In another embodiment, after the metadata server 11 transmits the connection information report message 108 or the logout response message 116 to the target user device, the processor 115 further receives an execution code 118 from the target user device via the network interface 111 to determine whether the execution code 118 is in a successful status. If the execution code 118 is in the successful status, then the processor 115 updates the system topology information. On the contrary, if the execution code 118 is in the failed status, then the processor 115 will not update the system topology information.

For example, when the network device 13 belongs to the user device UE4 of FIG. 10, the processor 135 of the network device 13 adds the connection information of at least one of the storage servers S1, S2 and S3 to the connection configuration according to the connection information report message 112, and then the processor 135 further tries to connect to at least one of the storage servers S1, S2 and S3 via the network interface 131 according to the connection configuration, and generates the execution code 118 based on the connection result and transmits the execution code 118 to the metadata server 11 via the network interface 131.

As another example, when the network device 13 belongs to the user device UE3 of FIG. 11, after the logout response message 116 is received via the network interface 131, the processor 135 removes the connection information of the storage server S3 from the connection configuration and interrupts the connection with the storage server S3. Then, after the connection is interrupted, the processor 135 generates the execution code 118 and transmits the execution code 118 to the metadata server 11 via the network interface 131. It shall be appreciated that, when the network device 13 logs out from the DFS 3, the processor 135 will not generate the execution code 118 until the connection is interrupted, so the execution code 118 transmitted in this case is surely in the successful status.

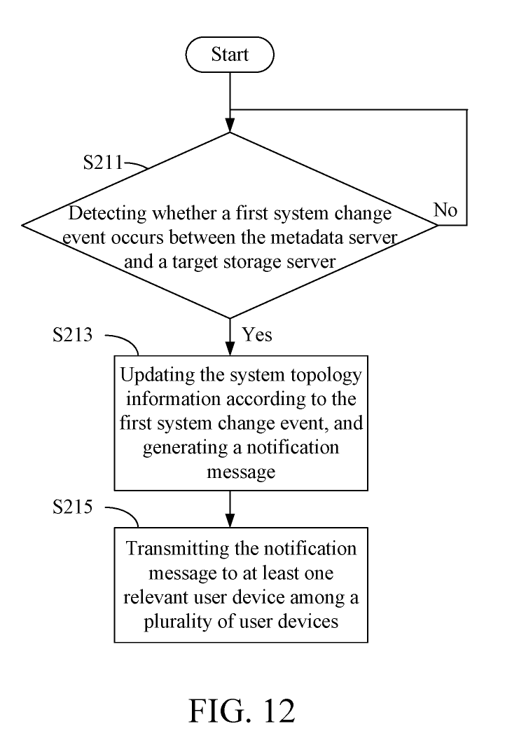

A fourth embodiment of the present invention is an automatic resource management method, and a flowchart diagram of the method is as shown in FIG. 12. The automatic resource management method of the present invention is adapted for use in a metadata server (e.g., the metadata server 11 of the aforesaid embodiments). The metadata server is used in a distributed file system (DFS) and comprises a network interface, a storage and a processor. The DFS comprises the metadata server, a plurality of storage servers and a plurality of user devices. The network interface is connected to the storage servers and the user devices via a network. The storage stores system topology information which records connection relationships between the storage servers and the user devices. The automatic resource management method is executed by the processor.

First, in step S211, it is detected whether a first system change event occurs between the metadata server and a target storage server. If the first system change event does not occur, then the step S211 is executed repeatedly to continuously monitor whether the first system change event occurs between the metadata server and a target storage server. On the contrary, if the first system change event occurs, then step S213 is executed to update the system topology information stored in the storage according to the first system change event, and generate a notification message in response to the update on the system topology information.

Next, in step S215, the notification message is transmitted to at least one relevant user device among the user devices via the network interface according to the connection relationships recorded in the system topology information. Specifically, as described above, the first system change event is to add the target storage server into the DFS or to remove the target storage server from the DFS. For example, when the first system change event is to add the target storage server into the DFS, the notification message generated in the step S213 is to enable each of the at least one relevant user device to add connection information of the target storage server into a connection configuration stored in the relevant user device according to the notification message. As another example, when the first system change event is to remove the target storage server from the DFS, the notification message generated in the step S213 is to enable each of the at least one relevant user device to remove the connection information of the target storage server from the connection configuration stored in the relevant user device according to the notification message.

Moreover, in another embodiment, the automatic resource management method of the present invention may further comprise the following step of: when the first system change event is to add the target storage server into the DFS, adding a shared folder in the storage so as to allocate a storage resource of the target storage server into the added shared folder, and updating the system topology information. Additionally, in another embodiment, the automatic resource management method of the present invention may further comprise the following step of: when the first system change event is to add the target storage server into the DFS, determining that the number of shared folders has reached a threshold so as to allocate a storage resource of the target storage server to a shared folder in the storage, and updating the system topology information.

Furthermore, in another embodiment, the automatic resource management method of the present invention may further comprise the following step of: when the first system change event is to add the target storage server into the DFS, calculating a storage resource of each of the storage servers so as to allocate a storage resource of the target storage server to a shared folder of one of the storage servers which has the minimum storage resource, and updating the system topology information. Moreover, in other embodiments, the automatic resource management method of the present invention may further comprise the following step of: after the notification message is transmitted to the at least one relevant user device, receiving an execution code from each of the at least one relevant user device respectively so as to determine whether each of the execution codes is in a successful status, and if the execution code is in the successful status, updating the system topology information.

It shall be appreciated that, as can be readily appreciated by those of ordinary skill in the art based on the aforesaid description, during the execution of the automatic resource management method of the present invention, the step S211 is executed repeatedly to detect whether there is a new target storage server (i.e., detect whether a storage server is added into the DFS or whether a storage server is removed from the DFS at all times), and meanwhile, the subsequent relevant steps are executed in response to the result of the detection. Moreover, in addition to the aforesaid steps, the automatic resource management method of this embodiment can also execute all the operations and have all the corresponding functions set forth in the aforesaid embodiments. How this embodiment executes these operations and has these functions will be readily appreciated by those of ordinary skill in the art based on the disclosure of the aforesaid embodiments, and thus will not be further described herein.

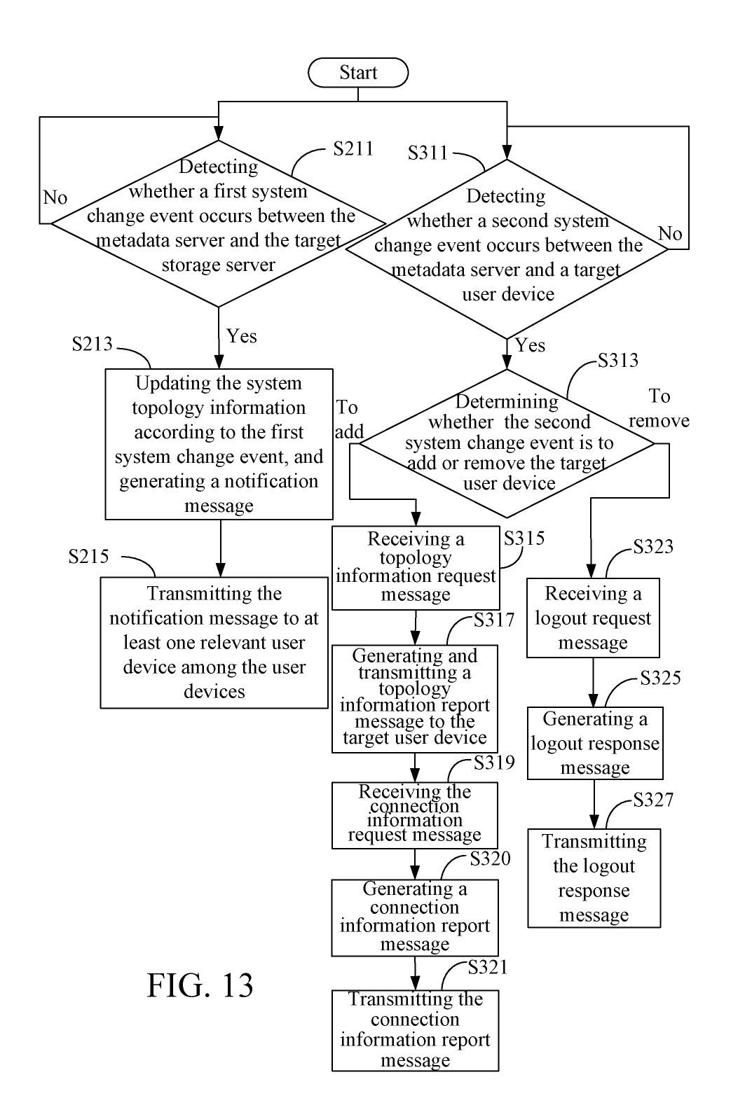

A fifth embodiment of the present invention is an automatic resource management method, and a flowchart diagram of the method is as shown in FIG. 13. This embodiment is an extension of the fourth embodiment. In addition to the steps described in the fourth embodiment, the automatic resource management method of the present invention further comprises the following steps.

In step S311, it is detected whether a second system change event occurs between the metadata server and a target user device. If the second system change event does not occur, then the step S311 is executed repeatedly to continuously monitor whether the second system change event occurs between the metadata server and a target user device. On the contrary, if the second system change event occurs, then step S313 is executed to determine whether the second system change event is to add the target user device into the DFS or remove the target user device from the DFS.

Next, when the second system change event is to add the target user device into the DFS, step S315 is executed to receive a topology information request message from the target user device via the network interface. Thereafter, in step S317, a topology information report message is generated according to the topology information request message and the topology information report message is transmitted to the target user device via the network interface. In this way, the target user device may select at least one shared folder from the storage according to the topology information report message and transmit a connection information request message to the metadata server.

Then, in step S319, the connection information request message is received via the network interface, and in step S320, a connection information report message is generated. Thereafter, in step S321, the connection information report message is transmitted to the target user device via the network interface. Accordingly, the target user device may add connection information of at least one of the storage servers into a connection configuration stored in the target user device according to the connection information report message.

On the other hand, when the second system change event is to remove the target user device from the DFS, step S323 is executed to receive a logout request message from the target user device via the network interface. Then, in step S325, a logout response message is generated according to the logout request message, and in step S327, the logout response message is transmitted to the target user device via the network interface. In this way, the target user device removes connection information of at least one of the storage servers from the connection configuration stored in the target user device in response to the logout response message.

Moreover, in other embodiments, the automatic resource management method of the present invention may further comprise the following step of: after the connection information report message or the logout response message is transmitted to the target user device, receiving an execution code from the target user device via the network interface to determine whether the execution code is in a successful status; and if the execution code is in the successful status, updating the system topology information.

It shall be appreciated that, as can be readily appreciated by those of ordinary skill in the art based on the aforesaid description, during the execution of the automatic resource management method of the present invention, the step S211 is executed repeatedly to detect whether there is a new target storage server (i.e., detect whether a storage server is added into the DFS or whether a storage server is removed from the DFS at all times) and the step S311 is executed repeatedly to detect whether there is a new target user device (i.e., detect whether a user device is added into the DFS or whether a user device is removed from the DFS at all times), and meanwhile, the subsequent relevant steps are executed in response to the results of the detection. In addition to the aforesaid steps, the automatic resource management method of this embodiment can also execute all the operations and have all the corresponding functions set forth in the aforesaid embodiments. How this embodiment executes these operations and has these functions will be readily appreciated by those of ordinary skill in the art based on the disclosure of the aforesaid embodiments, and thus will not be further described herein.

According to the above descriptions, the present invention provides an automatic resource management mechanism implemented in a distributed file system (DFS). In the automatic resource management mechanism, the system change events are automatically detected to automatically update the system topology information via the metadata server. Meanwhile, in response to the update on the system topology information, the notification message is automatically generated and transmitted to the relevant user devices so that each of the user devices automatically updates the connection between the user device and the storage server. Thus, the automatic management mechanism of the present invention can effectively reduce the complicated manual operations in the DFS and allow the user devices to change their connection configuration settings in real time in response to the change of the storage server in the DFS.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A metadata server for a distributed file system (DFS), the DFS comprising the metadata server, a plurality of storage servers and a plurality of user devices, the metadata server comprising:
a network interface, being connected to a network and connected to the storage servers and the user devices via the network;
a storage, being configured to store system topology information which records connection relationships between the storage servers and the user devices; and
a processor, being electrically connected to the network interface and the storage and configured to execute the following operations:
detecting whether a first system change event occurs between the metadata server and a target storage server; and
if the first system change event occurs, then updating the system topology information according to the first system change event, generating a notification message in response to the update on the system topology information, and transmitting the notification message to at least one relevant user device among the user devices via the network interface according to the connection relationships recorded in the system topology information.

2. The metadata server of claim 1, wherein the first system change event is to add the target storage server into the DFS or to remove the target storage server from the DFS.

3. The metadata server of claim 2, wherein when the first system change event is to add the target storage server into the DFS, the processor transmits the notification message to the at least one relevant user device via the network interface so that each of the at least one relevant user device adds connection information of the target storage server into a connection configuration stored in the relevant user device according to the notification message, and when the first system change event is to remove the target storage server from the DFS, the processor transmits the notification message to the at least one relevant user device via the network interface so that each of the at least one relevant user device removes the connection information of the target storage server from the connection configuration stored in the relevant user device according to the notification message.

4. The metadata server of claim 3, wherein when the first system change event is to add the target storage server into the DFS, the processor adds a shared folder in the storage so as to allocate a storage resource of the target storage server into the shared folder and updates the system topology information.

5. The metadata server of claim 3, wherein when the first system change event is to add the target storage server into the DFS, the processor further determines that a number of shared folders has reached a threshold so as to allocate a storage resource of the target storage server to a shared folder in the storage and updates the system topology information.

6. The metadata server of claim 3, wherein when the first system change event is to add the target storage server into the DFS, the processor calculates a storage resource of each of the storage servers so as to allocate a storage resource of the target storage server to a shared folder of one of the storage servers which has a minimum storage resource, and updates the system topology information.

7. The metadata server of claim 1, wherein after transmitting the notification message to the at least one relevant user device, the processor further receives an execution code from each of the at least one relevant user device respectively and, for each of the execution codes, the processor further determines whether the execution code is in a successful status, and if the execution code is in the successful status, the processor updates the system topology information.

8. The metadata server of claim 1, wherein the processor further executes the following operations:
detecting whether a second system change event occurs between the metadata server and a target user device;
when the second system change event is to add the target user device into the DFS, receiving a topology information request message from the target user device via the network interface so as to generate a topology information report message according to the topology information request message and transmit the topology information report message to the target user device via the network interface so that the target user device selects at least one shared folder from the storage according to the topology information report message and transmits a connection information request message to the metadata server; and after the connection information request message is received, generating a connection information report message and transmitting the connection information report message to the target user device via the network interface so that the target user device adds connection information of at least one of the storage servers into a connection configuration stored in the target user device; and
when the second system change event is to remove the target user device from the DFS, receiving a logout request message from the target user device via the network interface so as to generate a logout response message according to the logout request message and transmit the logout response message to the target user device via the network interface so that the target user device removes connection information of at least one of the storage servers from the connection configuration stored in the target user device in response to the logout response message.

9. The metadata server of claim 8, wherein after transmitting the connection information report message or the logout response message to the target user device, the processor further receives an execution code from the target user device via the network interface to determine whether the execution code is in a successful status, and if the execution code is in the successful status, the processor updates the system topology information.

10. An automatic resource management method for a metadata server, the metadata server being used in a distributed file system (DFS) and comprising a network interface, a storage and a processor, the DFS comprising the metadata server, a plurality of storage servers and a plurality of user devices, the network interface connecting to the storage servers and the user devices via a network, the storage being configured to store system topology information which records connection relationships between the storage servers and the user devices, and the automatic resource management method being executed by the processor, the method comprising:
(a) detecting whether a first system change event occurs between the metadata server and a target storage server; and
(b) if the first system change event occurs, then updating the system topology information according to the first system change event, generating a notification message in response to the update on the system topology information, and
transmitting the notification message to at least one relevant user device among the user devices via the network interface according to the connection relationships recorded in the system topology information.

11. The automatic resource management method of claim 10, wherein the first system change event is to add the target storage server into the DFS or to remove the target storage server from the DFS.

12. The automatic resource management method of claim 11, wherein when the first system change event is to add the target storage server into the DFS, the notification message generated in the step (b) is to enable each of the at least one relevant user device to add connection information of the target storage server into a connection configuration stored in the relevant user device; and when the first system change event is to remove the target storage server from the DFS, the notification message generated in the step (b) is to enable each of the at least one relevant user device to remove the connection information of the target storage server from the connection configuration stored in the relevant user device according to the notification message.

13. The automatic resource management method of claim 12, further comprising:
when the first system change event is to add the target storage server into the DFS, adding a shared folder in the storage so as to allocate a storage resource of the target storage server into the shared folder, and updating the system topology information.

14. The automatic resource management method of claim 12, further comprising:
when the first system change event is to add the target storage server into the DFS, determining that the number of the shared folders has reached a threshold so as to allocate a storage resource of the target storage server to a shared folder in the storage, and updating the system topology information.

15. The automatic resource management method of claim 12, further comprising:
when the first system change event is to add the target storage server into the DFS, calculating a storage resource of each of the storage servers so as to allocate a storage resource of the target storage server to a shared folder of one of the storage servers which has a minimum storage resource, and updating the system topology information.

16. The automatic resource management method of claim 10, further comprising:
after the notification message is transmitted to the at least one relevant user device, receiving an execution code from each of the at least one relevant user device respectively so as to determine whether each of the execution codes is in a successful status, and if the execution code is in the successful status, updating the system topology information.

17. The automatic resource management method of claim 10, further comprising:
(c) detecting whether a second system change event occurs between the metadata server and a target user device;
(d) when the second system change event is to add the target user device into the DFS, receiving a topology information request message from the target user device via the network interface so as to generate a topology information report message according to the topology information request message and transmit the topology information report message to the target user device via the network interface so that the target user device selects at least one shared folder from the storage according to the topology information report message and transmits a connection information request message to the metadata server, and after the connection information request message is received via the network interface, generating a connection information report message and transmitting the connection information report message to the target user device via the network interface so that the target user device adds connection information of at least one of the storage servers into a connection configuration stored in the target user device; and
(e) when the second system change event is to remove the target user device from the DFS, receiving a logout request message from the target user device via the network interface so as to generate a logout response message according to the logout request message and transmit the logout response message to the target user device via the network interface so that the target user device removes connection information of at least one of the storage servers from the connection configuration stored in the target user device in response to the logout response message.

18. The automatic resource management method of claim 17, further comprising:
after the connection information report message or the logout response message is transmitted to the target user device, receiving an execution code from the target user device via the network interface to determine whether the execution code is in a successful status, and if the execution code is in the successful status, updating the system topology information.

19. A network device for a distributed file system (DFS), the DFS comprising a metadata server, a plurality of storage servers and a plurality of user devices, the network device comprising:
a storage, being configured to store a connection configuration;
a network interface, being connected to a network and connected to the metadata server via the network; and
a processor, being electrically connected to the network interface and the storage;
wherein:
the metadata server stores system topology information which records connection relationships between the storage servers and the user devices;
the metadata server detects whether a first system change event occurs between the metadata server and a target storage server; and if the first system change event occurs, then updates the system topology information according to the first system change event, generates a notification message in response to the update on the system topology information, and transmits the notification message to at least one relevant user device among the user devices according to the connection relationships recorded in the system topology information; and
if the network device is one of the at least one relevant user device, the network interface receives the notification message from the metadata server.

20. The network device of claim 19, wherein when the first system change event is to add the target storage server into the DFS, the processor adds connection information of the target storage server into the connection configuration according to the notification message, and when the first system change event is to remove the target storage server from the DFS, the processor removes the connection information of the target storage server from the connection configuration according to the notification message.

21. The network device of claim 20, wherein the processor generates an execution code after trying to connect to the target storage server according to the connection configuration, and transmits the execution code to the metadata server.

22. The network device of claim 19, wherein the metadata server detects whether a second system change event occurs between the metadata server and the network device,
when the second system change event is to add the network device into the DFS, the processor executes the following operations:
transmitting a topology information request message to the metadata server via the network interface;
receiving a topology information report message from the metadata server via the network interface; and
selecting at least one shared folder from the metadata server according to the topology information report message so as to generate a connection information request message and transmit the connection information request message to the metadata server via the network interface, and receiving a connection information report message from the metadata server via the network interface so as to add connection information of at least one of the storage servers into the connection configuration; and
when the second system change event is to remove the network device from the DFS, the processor generates a logout request message, transmits the logout request message to the metadata server via the network interface, and receives a logout response message from the metadata server so as to remove connection information of at least one of the storage servers from the connection configuration in response to the logout response message.

23. The network device of claim 22, wherein after trying to connect to at least one of the storage servers according to the connection configuration or interrupting a connection with at least one of the storage servers, the processor further generates an execution code and transmits the execution code to the metadata server via the network interface.
